(19) United States
(12) Patent Application Publication
(10) Pub. No.: US 2016/0359387 A1
(43) Pub. Date: Dec. 8, 2016

(54) SECONDARY ENCAPSULATION WATERPROOF STRUCTURE FOR HYDROELECTRIC POWER GENERATOR

(71) Applicant: Xiamen Runner Industrial Corporation, Xiamen (CN)

(72) Inventors: Zhao-yi Zhuo, Xiamen (CN); Sheng-jun Du, Xiamen (CN); Sheng-chao Dai, Xiamen (CN); Wen-hua Ye, Xiamen (CN)

(21) Appl. No.: 15/169,158

(22) Filed: May 31, 2016

(30) Foreign Application Priority Data
Jun. 5, 2015 (CN) 201520382668.7

(51) Int. Cl. H02K 5/128; H02K 1/27

(52) U.S. Cl. CPC H02K 5/128; H02K 1/272; H02K 2005/1287

(57) ABSTRACT

A secondary encapsulation waterproof structure for hydroelectric power generator comprises: a magnet, sleeved on and around a rotation axis of a generator; a coil, disposed around the magnet; and a magnet encapsulation component, sleeved around the magnet. The magnet encapsulation component includes a column-shaped plastic sleeve, a column-shaped rubber sleeve, or a column-shaped ceramic sleeve, sleeved around the magnet. The secondary encapsulation waterproof structure for a hydroelectric power generator is simple in construction, and it utilizes the secondary encapsulation waterproof structure to overcome the insufficient waterproof capability of the prior art for a hydroelectric power generator obtained through barrel plating, to raise its waterproof and corrosion resistance capability, in achieving prolonged service life for the hydroelectric power generator.

### BACKGROUND OF THE INVENTION

Field of the Invention

The present invention relates to a waterproof structure, and in particular to a secondary encapsulation waterproof structure for a hydroelectric power generator.

The Prior Arts

Presently, the magnet used in a hydroelectric power generator utilizes barrel plating technology for waterproofing, yet the magnet thus produced is rather difficult to pass the Copper-Accelerated Acetic Acid-Salt Spray (CASS) 4H Test. As such, the waterproof capability of the magnet is insufficient.

Therefore, presently, the waterproof capability of the magnet produced by barrel plating is not quite satisfactory, and it leaves much room for improvement.

### SUMMARY OF THE INVENTION

In view of the problems and drawbacks of the prior art, the present invention provides a secondary encapsulation waterproof structure for a hydroelectric power generator, to raise the waterproof capability of the magnet.

In order to achieve the objective mentioned above, the present invention provides a secondary encapsulation waterproof structure for a hydroelectric power generator, comprising: a magnet, sleeved on and around a rotation axis of a power generator; a coil, disposed around the magnet; and a magnet encapsulation component, sleeved around the magnet.

In an aspect of the present invention, the magnet encapsulation component includes one of the followings: a column-shaped plastic sleeve, a column-shaped rubber sleeve, and a column-shaped ceramic sleeve, sleeved around the magnet.

In another aspect of the present invention, a through hole is provided in a center of the magnetic for the rotational axis to penetrate through. The magnet encapsulation component includes a magnetic lining, inserted in the through hole of the magnet; and a column-shaped plastic sleeve, with its one end provided with an opening. Wherein magnetic lining includes: a tube-shaped body, inserted into the through hole and pressing tightly against an inner wall of the through hole; and a bottom seat, disposed at one end of the tube-shaped body pressing tightly at one end of the magnet 10.

In yet another aspect of the present invention, the secondary encapsulation waterproof structure for a hydroelectric power generator further includes: a shell, sleeved around the magnet encapsulation component, and sleeved on and around the rotation axis; two washers, provided in the shell, and each disposed on each side of the magnet encapsulation component; and two bearings, provided in the shell, and each disposed on each side of the magnet encapsulation component.

In a further aspect of the present invention, the secondary encapsulation waterproof structure for a hydroelectric power generator further includes: a magnetism proof sleeve, sleeved around the coil; a van wheel, disposed at one side of the rotation axis; and a water slanting plate, provided with a water input end, and disposed at one side of the rotation axis.

Compared with the Prior Art, the present invention has the advantages that, it is simple in construction, and it utilizes the secondary encapsulation waterproof structure to overcome the defects of insufficient waterproof capability of the prior art for the magnet of hydroelectric power generator obtained through barrel plating, to raise its waterproof and corrosion resistance capability, in achieving prolonged service life for the a hydroelectric power generator.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is an exploded view of a hydroelectric power generator having a magnet encapsulation component according to a first embodiment of the present invention;

FIG. 2 is an exploded view of a magnet encapsulation component according to a first embodiment of the present invention;

FIG. 3 is a cross section view of a magnet encapsulation component according to a first embodiment of the present invention;

FIG. 4 is an exploded view of a hydroelectric power generator having a magnet encapsulation component according to a second embodiment of the present invention;

FIG. 5 is an exploded view of a magnet encapsulation component according to a second embodiment of the present invention;

FIG. 6 is a cross section view of a magnet encapsulation component according to a second embodiment of the present invention; and

FIG. 7 is a cross section view of a hydroelectric power generator having a magnet encapsulation component according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

The present invention provides a secondary encapsulation waterproof structure for a hydroelectric power generator, comprising: a magnet 10, sleeved on and around a rotation axis 40 of a power generator; a coil 20, disposed around the magnet 10; and a magnet encapsulation component 30, sleeved around the magnet 10.

In the following, two embodiments are described through using two kinds of magnet encapsulation components 30.

### Embodiment 1

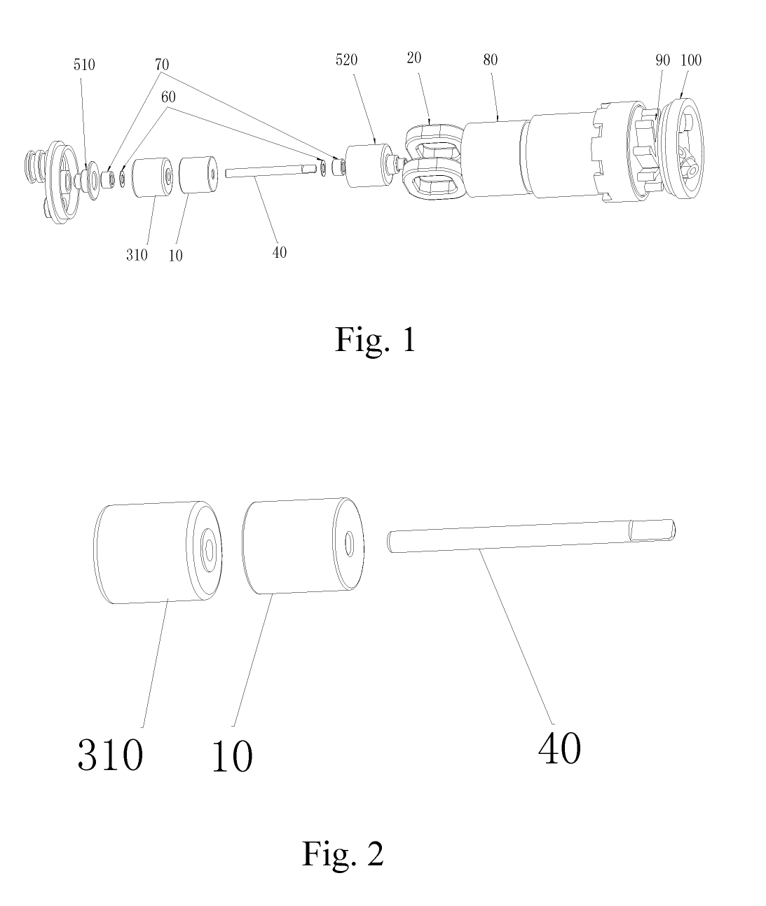

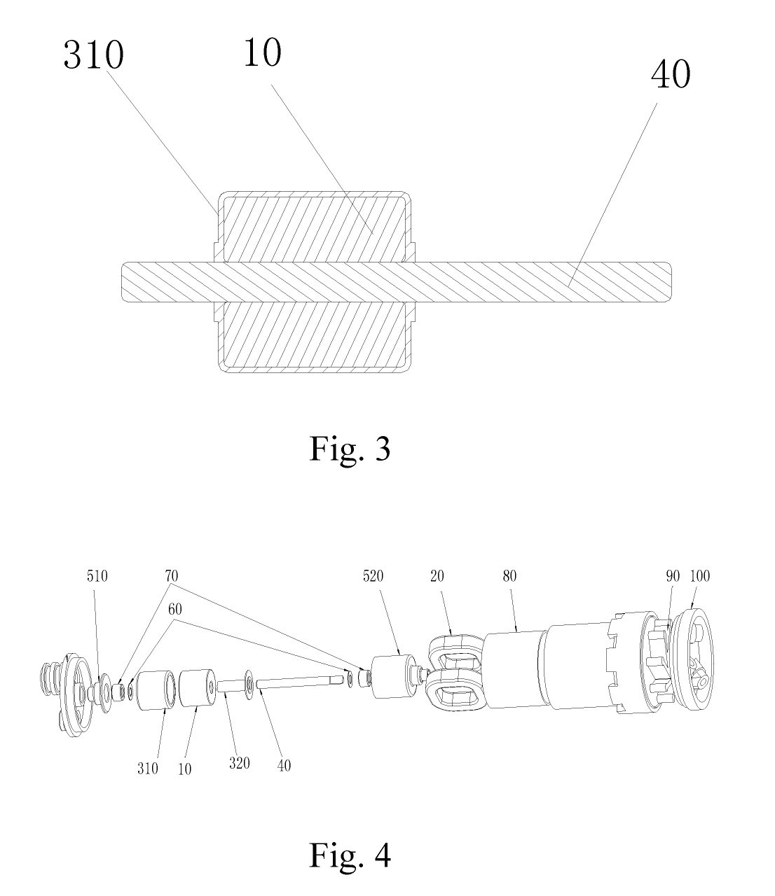

Refer to FIGS. 1 to 3 respectively for an exploded view of a hydroelectric power generator having a magnet encapsulation component according to a first embodiment of the present invention; an exploded view of a magnet encapsulation component according to a first embodiment of the present invention; and a cross section view of a magnet encapsulation component according to a first embodiment of the present invention.

As shown in FIGS. 1 to 3, the magnet encapsulation component 30 contains a column-shaped plastic sleeve 310, sleeved around the magnet 10. The column-shaped plastic sleeve 310 is of a hollow structure, with its two ends provided with openings for the rotation axes to penetrate through. In forming the column-shaped plastic sleeve 310, after the rotation axis 40 is sleeved into the magnet 10, perform encapsulating into shape, to form the column-shaped plastic sleeve 310.

Around the magnet encapsulation component 30 is sleeved with a shell, that is also sleeved on the rotation axis 40. The shell is formed by two fastening portions (510,520) fastening to each other. In the shell, and on both sides of the magnet encapsulation component 30 are each provided with a washer 60 and a bearing 70. A magnetism proof sleeve 80 is sleeved around the coil 20, while a van wheel 90, and a water slanting plate 100 having a water input end, are disposed at one side of the rotation axis 40. In operation, water flows in from the water slanting plate 100 slantwise to impinge upon the van wheel 90, to bring the rotation axis 40 into rotation, in achieving electricity generation.

### Embodiment 2

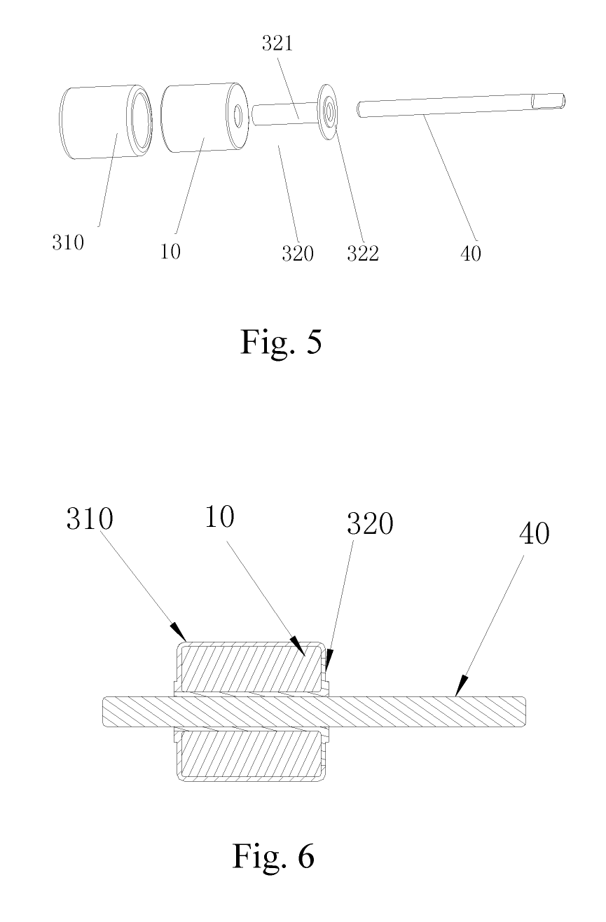

Refer to FIGS. 4 to 6 respectively for an exploded view of a hydroelectric power generator having a magnet encapsulation component according to a second embodiment of the present invention; an exploded view of a magnet encapsulation component according to a second embodiment of the present invention; and a cross section view of a magnet encapsulation component according to a second embodiment of the present invention.

As shown in FIGS. 4 to 6, a through hole is provided in a center of the magnetic 10 for the rotational axis 40 to penetrate through. The magnet encapsulation component 30 includes a magnetic lining 320, disposed in the through hole of the magnet 10, and a column-shaped plastic sleeve 310, with its one end provided with an opening.

The magnetic lining 320 includes: a tube-shaped body 321, inserted into the through hole and pressing tightly against an inner wall of the through hole; and a bottom seat 322, disposed at one end of the tube-shaped body 321 pressing tightly against one end of the magnet 10.

In forming the column-shaped plastic sleeve 310, firstly insert the magnetic lining 320 formed into shape into the through hole of the magnet 10, then perform encapsulating into shape around the magnet 10, to form the column-shaped plastic sleeve 310. The descriptions not mentioned in Embodiment 2 are the same as the Embodiment 1, and they are omitted here for brevity.

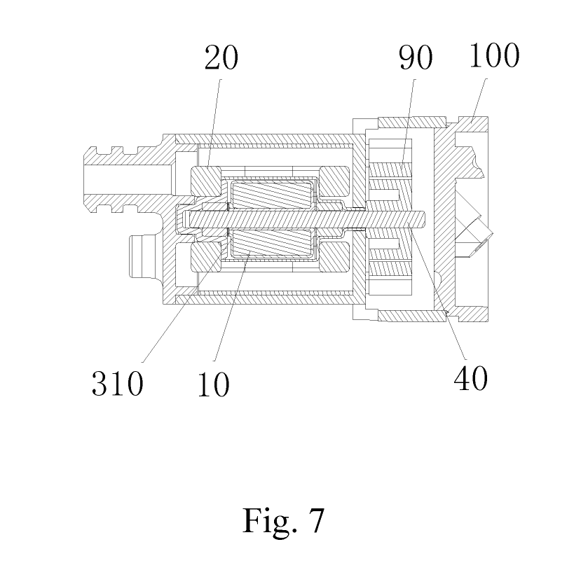

Finally, refer to FIG. 7 for a cross section view of a hydroelectric power generator having a magnet encapsulation component according to the present invention.

In application, the column-shaped plastic sleeve 310 can also be replaced with column-shaped rubber sleeve 310 or column-shaped ceramic sleeve 310

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A secondary encapsulation waterproof structure for a hydroelectric power generator, comprising:
a magnet, sleeved on and around a rotation axis of a power generator;
a coil, disposed around the magnet; and
a magnet encapsulation component, sleeved around the magnet.

2. The secondary encapsulation waterproof structure for a hydroelectric power generator as claimed in claim 1, wherein the magnet encapsulation component includes one of the followings: a column-shaped plastic sleeve, a column-shaped rubber sleeve, and a column-shaped ceramic sleeve, sleeved around the magnet.

3. The secondary encapsulation waterproof structure for a hydroelectric power generator as claimed in claim 1, wherein
a through hole is provided in a center of the magnetic for the rotational axis to penetrate through;
the magnet encapsulation component includes a magnetic lining, disposed in the through hole of the magnet, and a column-shaped plastic sleeve, with its one end provided with an opening;
wherein magnetic lining includes: a tube-shaped body, inserted into the through hole and pressing tightly against an inner wall of the through hole; and a bottom seat, disposed at one end of the tube-shaped body pressing tightly at one end of the magnet.

4. The secondary encapsulation waterproof structure for a hydroelectric power generator as claimed in claim 3, further comprising:
a shell, sleeved around the magnet encapsulation component, and sleeved on and around the rotation axis;
two washers, provided in the shell, and each disposed on each side of the magnet encapsulation component; and
two bearings, provided in the shell, and each disposed on each side of the magnet encapsulation component.

5. The secondary encapsulation waterproof structure for a hydroelectric power generator as claimed in claim 1, further comprising:
a magnetism proof sleeve, sleeved around the coil;
a van wheel, disposed at one side of the rotation axis; and
a water slanting plate provided with a water input end, and disposed at one side of the rotation axis.
